(19) United States
(12) Patent Application Publication
(10) Pub. No.: US 2007/0237506 A1
(43) Pub. Date: Oct. 11, 2007

(54) IMAGE BLURRING REDUCTION

(75) Inventors: Ikumi Minema, Yokohama (JP); Nobuyoshi Tanaka, Yokohama (JP); Masaru Sakai, Tokyo (JP)

Correspondence Address: FISH & RICHARDSON PC, P.O. BOX 1022, MINNEAPOLIS, MN, 55440-1022, US

(73) Assignee: WINBOND ELECTRONICS CORPORATION, Hsinchu (TW)

(21) Appl. No.: 11/676,021

(22) Filed: Feb. 16, 2007

(30) Foreign Application Priority Data
Apr. 6, 2006 (JP) 2006-105004
Oct. 26, 2006 (JP) 2006-291594

(51) Int. Cl. G03B 17/00

(52) U.S. Cl. 396/52

(57) ABSTRACT

Operating a camera by detecting a motion of a camera, capturing an image of an object at a first shutter speed determined by the camera if camera motion is not detected, and capturing the image of the object at a second shutter speed determined by the camera if camera motion is detected, the second shutter speed being higher than the first shutter speed. Image data corresponding to the captured image are stored in a storage device.

### CROSS REFERENCE TO RELATED APPLICATIONS

This application claims priority to Japanese patent applications serial no. 2006-105004, filed Apr. 6, 2006, and serial no. 2006-291594, filed Oct. 26, 2006. The contents of the above two applications are incorporated by reference.

### BACKGROUND

This description relates to image blurring reduction.

A digital still camera includes an image sensor, such as a charged coupled device (CCD) sensor or a complementary metal oxide semiconductor (CMOS) sensor, to sense light and generate image data that are processed and stored in a recording medium, such as a flash memory card. When the digital camera is held by hand and the shutter speed is low, the image captured by the camera may be blurred due to movement of the camera. One method of reducing blurriness in images captured by the camera is to successively capture four images and store the four images in a memory. If the camera moved when the images were taken, a digital signal processor shifts some of the four images according to distances of camera movement and overlays the four images to form a combined image with reduced blurriness. Another method of reducing blurriness of images is to detect camera motion using a motion sensor and adjust the camera lens or image sensor mechanically to compensate for the movement of the camera.

### SUMMARY

In one aspect, in general, a method of operating a camera includes detecting a motion of a camera, if camera motion is not detected, capturing an image of an object at a first shutter speed determined by the camera, if camera motion is detected, capturing the image of the object at a second shutter speed determined by the camera, the second shutter speed being higher than the first shutter speed, and storing image data corresponding to the captured image in a storage device.

Implementations of the display can include one or more of the following features. Detecting the motion of the camera includes comparing patterns in two preview images captured successively by the camera. Comparing patterns in the two preview images includes calculating correlations between a pattern at a location in a first one of the two preview images with patterns in corresponding neighboring locations in a second one of the two preview images. The method includes generating a motion value based on the comparison of the patterns in the two preview images, and determining that camera motion is not detected if the motion value is less than a predetermined threshold. Detecting the motion of the camera includes analyzing movements of a plurality of detection areas of an image sensor of the camera. The motion of the camera is represented by a sum of movement distances of the plurality of detection areas. The second shutter speed is determined based at least in part on a level of motion of the camera. The second shutter speed is determined based on a predetermined relationship to the first shutter speed.

The method includes applying a gain increase process to image data corresponding to the captured image when the image is captured using the second shutter speed. In some examples, the gain is increased by a ratio substantially equal to a ratio of the second shutter speed and the first shutter speed. In some examples, the gain is increased using a cell clustering method. Increasing the gain includes, to a readout value from each of some of the sensor cells of the camera, adding a readout value of at least one other neighboring sensor cell. In some examples, the gain increase process is performed by a digital multiplication method in which pixel values of the image are digitally multiplied by a gain multiplication ratio. In some examples, the method includes adaptively selecting the gain increase process from among at least two different gain increase processes, such as a cell clustering method and a digital multiplication method. The method includes determining the first shutter speed using an auto exposure module.

In another aspect, in general, a method includes capturing a first image of an object at a first shutter speed, and automatically, without specific control by a user, capturing a second image at a second shutter speed that is faster than the first shutter speed upon detecting movement of the camera while the first image is being captured.

Implementations of the display can include one or more of the following features. Measuring the movement of the camera includes using a mechanical sensor to measure the movement. The method includes applying a gain increase process to image data corresponding to the captured image when the image is captured using the second shutter speed. In some examples, the gain is increased by a ratio substantially equal to a ratio of the second shutter speed and the first shutter speed. In some examples, the gain is increased using a cell clustering method.

In another aspect, in general, a camera includes a motion detection module to detect motion of the camera, an image sensor to capture an image and generate an image signal, an image processing module to process the image signal from the image sensor and generate image data, and a control module to cause the image sensor to capture the image using a first exposure time if the camera motion is not detected, and cause the image sensor to capture the image using a second exposure time if the camera motion is detected, the second exposure time being shorter than the first exposure time.

Implementations of the display can include one or more of the following features. The camera includes an auto exposure module to determine the first exposure time. The camera includes a recording device for storing the image data. The controller causes first image data associated with the first image to be stored in the memory, and causes the first image data to be erased from the memory if the motion value is larger than the threshold value. In some examples, the motion detection module is configured to detect the camera motion by comparing patterns in a first preview image and a second preview image captured successively by the image sensor. The motion detection module is configured to compare patterns in the first and second preview images by calculating correlations between a pattern at a location in the first preview image with patterns in corresponding neighboring locations in the second preview image. The motion detection module is configured to generate a motion value based on the comparison of the patterns in the first and second preview images and determine that camera motion is not detected if the motion value is less than a predetermined threshold. The motion detection module is configured to detect the motion of the camera by analyzing movements of a plurality of detection areas of the image sensor. The motion detection module is configured to analyze movements of the detection areas by calculating a sum of movement distances of subpixels corresponding to the plurality of detection areas. In some examples, the motion detection module includes a mechanical motion sensor.

The image processing module is configured to increase a gain of the image signal associated with the second image. In some examples, the image processing module is configured to increase the gain according to a ratio of the first exposure time relative to the second exposure time. In some examples, the image processing module is configured to increase the gain using a cell clustering method. The image processing module is configured to increase the gain by adding, to a readout value of each of some sensor cells, a readout value of at least one other neighboring sensor cell.

In another aspect, in general, an apparatus includes means for capturing a first image at a first shutter speed, and means for automatically, without specific control by the user, capturing a second image at a second shutter speed that is faster than the first shutter speed upon detecting movement of the camera while the first image is being captured.

Implementations of the display can include one or more of the following features. The apparatus includes means for detecting the movement of the camera.

Other features and advantages of the invention are apparent from the following description, and from the claims.

### DESCRIPTION OF DRAWINGS

FIG. 1 shows a diagram of a digital camera.

FIG. 2 is a flow diagram of a process for operating the digital camera.

FIG. 3 is a timing diagram of events that occur during operation of the digital camera.

FIG. 4 is a graph showing a comparison of movements of the camera at different shutter speeds.

FIG. 5 is a graph showing a comparison of photo-carriers stored in an image-capturing device at different shutter speeds.

FIG. 6A is a diagram showing an arrangement of motion detection areas.

FIG. 6B is a diagram showing sensor cell arrays associated with a motion detection area.

FIGS. 7A, 7B, and 7C are diagrams showing an arrangement of green, red, and blue sensor cells, respectively.

FIGS. 8A and 8B are diagrams showing arrangements of sensor cells.

### DESCRIPTION

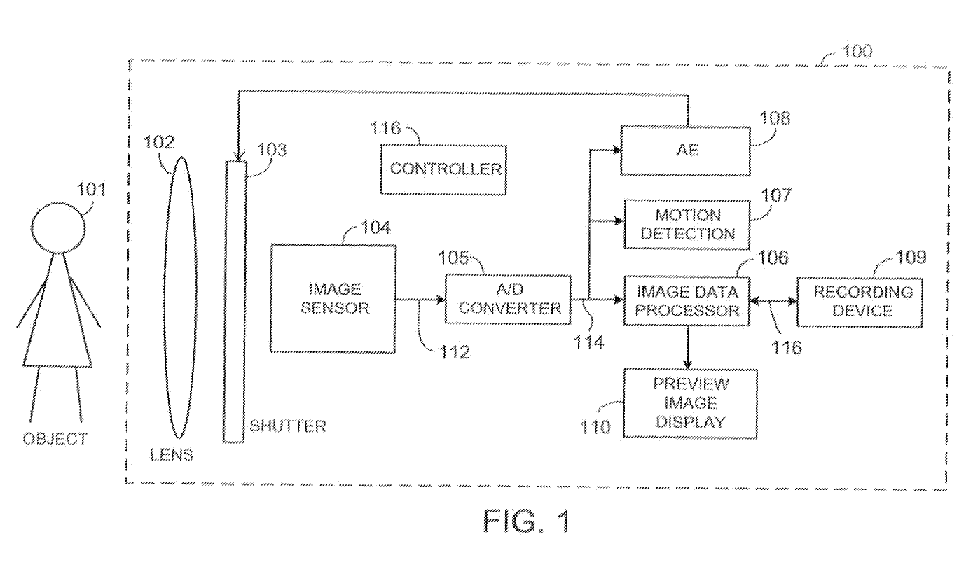

Referring to FIG. 1, an example of a digital camera 100 reduces blurring in images by increasing a shutter speed when camera motion is detected. In some examples, camera motion is sensed before an image is captured. If the camera motion is above a certain threshold, the image is captured using a high shutter speed. In some examples, camera motion is sensed while the image is being captured using a normal shutter speed. If the camera motion is above a certain threshold, the image being captured is discarded, and another image is captured using a higher shutter speed.

The digital camera 100 includes a lens module 102 for focusing an image of a person or an object 101 onto an image sensor 104 (e.g., a CCD or CMOS sensor). The image sensor 104 includes an array of sensor cells that convert light into analog electrical image signals 112 that are converted into digital image data 114 by an analog-to-digital (A/D) converter 105. In some examples, each sensor cell includes a color filter positioned in front of a photodetector. The color filters can allow red, green, or blue light to pass so that some cells detect red light, some cells detect green light, and some cells detect blue light.

The lens module 102 (or a body of the camera) may include a diaphragm that determines an aperture, which controls the amount of light reaching the image sensor 104 per unit of time. A shutter 103, controlled by an auto exposure module 108, determines an exposure time, which together with the aperture determines the amount of light that reaches the image sensor 104. The auto exposure module 108 determines the exposure time based on, among other factors, the intensity of incoming light and the size of the aperture. A higher shutter speed means that the shutter is open for a shorter amount of time. In this example, the shutter 103 is a mechanical shutter.

The digital image data 114 are sent to an image data processor 106, a motion detection module 107, and the auto exposure (AE) module 108. The motion detection block 107 detects camera motion by measuring differences between preview images. The image data processor 106 processes the digital image data 114 and generates still image data 116 that conforms to an industry standard, e.g., JPEG format. The still image data 116 are recorded in a recording device 109, which can include, e.g., flash memory. A preview image display 100 (which can be part of a viewfinder) shows preview images corresponding to optical images sensed by the image sensor 104. A controller 116 controls the operations of various components described above.

In the examples described below, it is assumed that the camera has been set to auto-exposure mode, in which the camera 100 automatically determines the shutter speed.

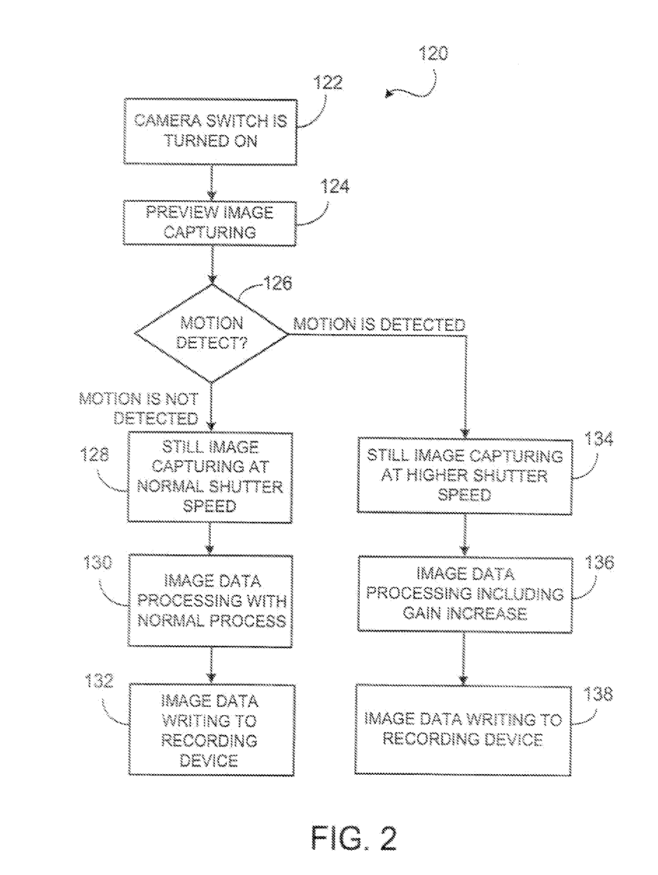

FIG. 2 shows an example of a process 120 for operating the digital camera 100 to capture an image with less blurriness. The camera 100 is turned on 122. Preview images are captured 124 and shown on the preview image display 110. A user half-presses a shutter button to cause the camera 100 to focus on the object 101 and determine a shutter speed. Motion detection is performed 126 by comparing differences in preview images captured just prior to the user pressing the shutter button in full to capture a still image.

If camera motion is not detected or is below a threshold value, the still image is captured 128 by the image sensor 104 at a normal shutter speed determined by the auto exposure module 108, and image data is generated. The image data are processed 130 by the image data processor 106 using a normal process, and the processed image data are written 132 into the recording device 109. The image data stored in the recording device 109 represent the final image that the user can view, print, or upload to a computer for further processing.

Here, “normal shutter speed” refers to a shutter speed determined by the auto exposure module 108 that takes into account, for example, the amount of light reaching the image sensors when a particular aperture is selected. The shutter speed is designed so that there is sufficient time for the image sensor 104 to collect enough light to generate an image having a proper brightness (as determined according to a pre-stored algorithm) and with sufficiently low noise, the exposure time also being sufficiently short to prevent over saturation of the image. In some examples, the normal shutter speed is determined without considering camera movement.

If camera motion is detected to be above the threshold value, the still image is captured 134 by the image sensor 104 at higher shutter speed. The higher shutter speed can be, e.g., N times faster than the normal shutter speed. The image data are processed 136 by the image data processor 106 using a process that includes a gain increase process. The processed image data are written 138 into the recording device 109.

Here, “higher shutter speed” refers to a shutter speed that is higher than the normal shutter speed. The higher shutter speed can be determined, for example, based on the normal shutter speed and the level of camera motion—the greater the camera motion, the higher the shutter speed. The higher shutter speed may depend on the particular type of sensor 104 and lens 102 being used. The higher shutter speed can also be determined by increasing normal shutter speed to n times the normal shutter speed, where n is a predetermined number.

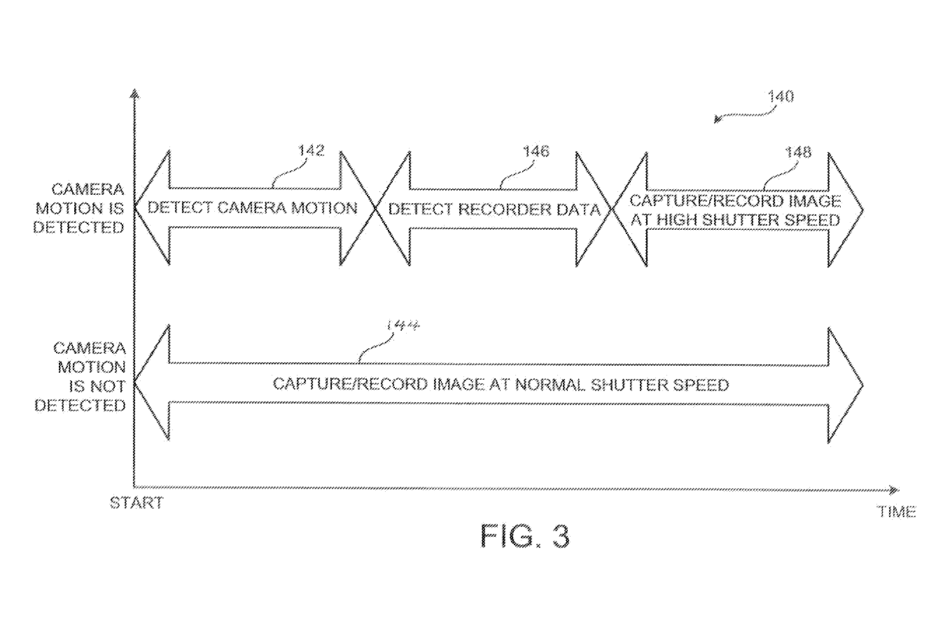

FIG. 3 is an example of events that occur in a process 140 for operating the digital camera 100. When a user fully presses the shutter button to capture a still image, motion detection is performed 142 at the same time that an initial still image is captured and recorded 144 using a normal shutter speed that is determined by the auto exposure module 108. In this example, instead of using the motion detection module 107 that detects camera motion by comparing preview images, the camera motion is detected using, e.g., an accelerometer that detects camera motion using a mechanical detection method. If camera motion is below a threshold value, image data corresponding to the initial image captured at the normal shutter speed are recorded as the final image in the recording device 109.

If camera motion is detected to be above the threshold value, the captured or recorded image data (if any) related to the image currently being captured in step 144 are deleted 146, and a new still image is captured 148 using a higher shutter speed (i.e., a shutter speed higher than the normal shutter speed determined by the auto exposure module 108). The new still image data are processed according to a gain increase process described below. The processed image data are recorded as a final still image in the recording device 109.

The gain increase process is described below.

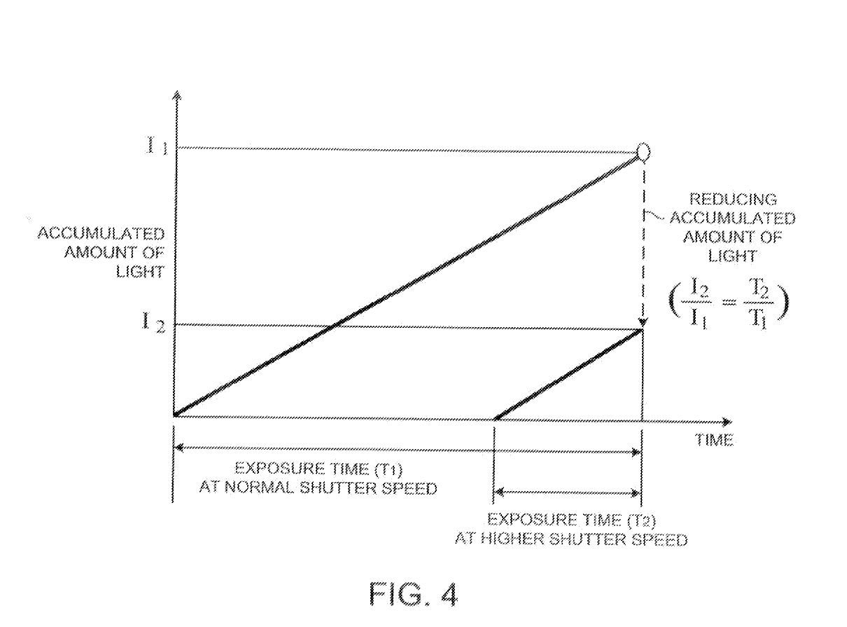

FIG. 4 shows a comparison of an accumulated amount of light when the normal shutter speed and the higher shutter speed are used. When a normal shutter speed is used, the shutter is open for a time period T1 and the accumulated amount of light received by the image sensor 104 is represented by I1. When a higher shutter speed is used, the shutter is open for a period T2 and the accumulated amount of light received by the image sensor 104 is represented by I2. The accumulated amount of light received by the image sensor 104 are substantially proportional to the duration that the shutter is opened, so I1:I2=T1:T2.

The period T1 for the normal shutter speed is the amount of time determined by the auto exposure module 108 that is sufficient to obtain an image with an appropriate brightness. Because the period T2 is shorter than T1, the accumulated amount of light received by the image sensor during the period T2 may not be sufficient to generate an image having the appropriate brightness. Accordingly, the second image that is captured using the higher shutter speed is processed using a gain increase process, in which the gain used for processing raw image data is increased by a ratio substantially equal to T₁/T2. The processed image is then stored in the recording device 109.

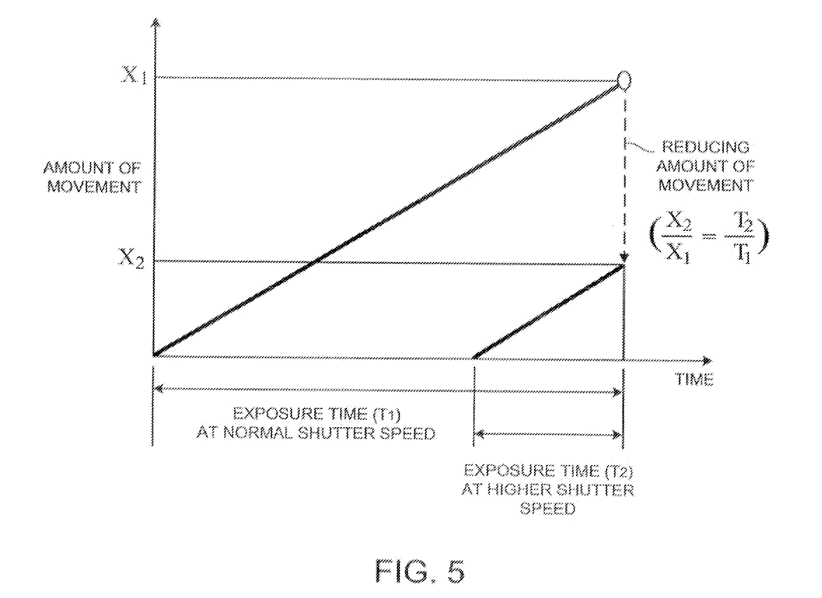

FIG. 5 shows a comparison of exemplar camera movements due to unsteady hands when the normal shutter speed and the higher shutter speed are used. When camera movement or shaking is caused by unsteady hands, the speed at which the camera moves or shakes is substantially constant within a short period of time, so the amount of camera movement that affects image clarity is substantially proportional to the time that the shutter 103 is open. In this example, the camera 100 moves a distance X1 or X2 when the normal or higher shutter speed, respectively, is used. By increasing the shutter speed (decreasing the amount of time that the shutter is open), the movement of the camera can be reduced when the image is captured, reducing blurring in the image. The amount of movement (e.g., X2) at the higher shutter speed is reduced by factor of T2/T1 compared to the amount of movement (e.g., X1) at the normal shutter speed, where T1 and T2 are the exposure time at the normal shutter speed and the exposure time at the higher shutter speed, respectively.

The following describes how the motion detection module 107 detects camera motion using preview images.

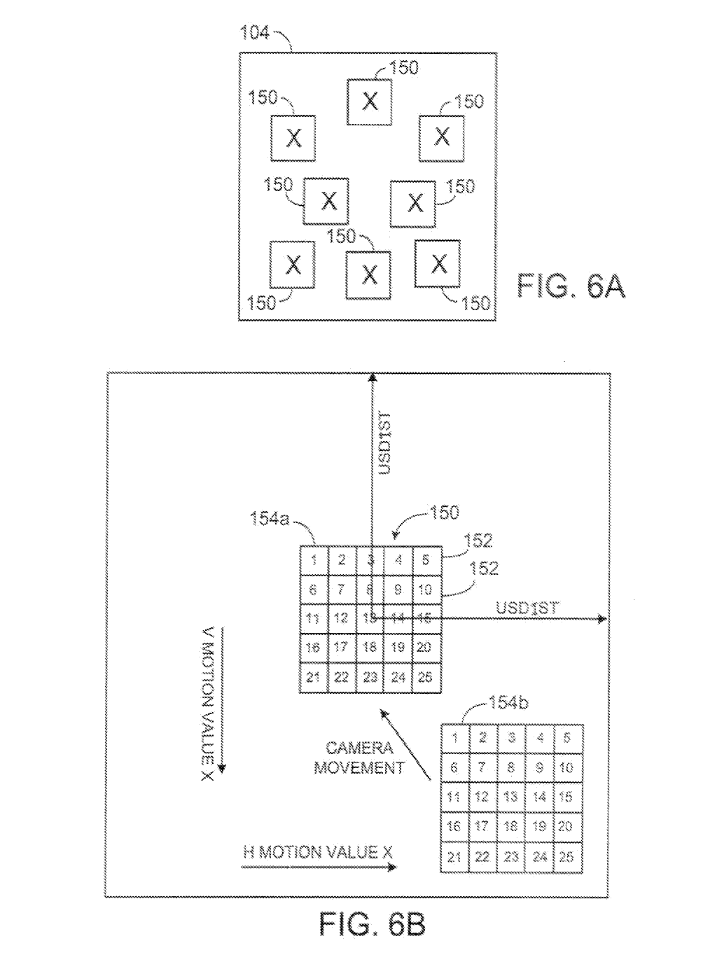

Referring to FIG. 6A, the image sensor 104 includes motion detection areas 150 that are used to detect camera motion. In this example, there are eight motion detection areas 150. The camera motion is estimated by the movements of the motion detection areas 150, which can be estimated by processing portions of images captured by the sensor cells in the motion detection areas 150.

The camera 100 provides a continuous live view on the preview image display 110 after the camera 100 is turned on. The image sensor 104 continuously captures preview images that are processed and shown on the preview image display 110. A memory buffer (not shown) is provided to store preview image data corresponding to the image shown on the preview image display 110. The memory buffer also stores pixel data of the motion detection areas 150 of a previous preview image. When the user half-presses the shutter button intending to capture an image, the pixel data corresponding to the motion detection areas 150 of a previous preview image are compared with the pixel data corresponding to the current preview image.

Referring to FIG. 6B, each motion detection area 150 includes an array of 5-by-5 sensor cells 152. The camera motion can be estimated by the movements of the motion detection areas 150, which can be estimated by calculating correlations of 5-by-5 arrays of subpixels in the previous and current preview images. The motion detection module 107 compares a 5-by-5 array of subpixels captured by each motion detection area 150 in the previous preview image with 5-by-5 arrays of subpixels in the corresponding position or nearby positions in the current preview image. Here, a “subpixel” refers to one of the red, green, or blue subpixels of a color pixel of an image.

For example, if the 5-by-5 array of subpixels captured by a detection area 150 is at a position 154a in the previous preview image, and the array highly correlates to a 5-by-5 array of subpixels at a position 154b in the current preview image, it indicates that the camera 100 has moved (or tilted) relative to objects (or portions of objects) represented by the 5-by-5 array of subpixels during the time that the two preview images were taken.

A motion value Xi (i=1 to n, where n is the number of motion detection areas 150, n=8 in this example) for each detection area 150 is calculated as the distance between the two highly correlated 5-by-5 arrays of subpixels in the two preview images. An average motion value X_ave is determined by X_ave=(X1+X2+ . . . +Xn)/n.

If X_ave is equal to or greater than a predetermined threshold value Xc, the controller 116 determines that the camera motion is equal to or above a certain threshold when the current preview image was taken, so the controller 116 causes a still image to be captured using a higher shutter speed. The still image is processed using a gain increase process and stored in the recording device 109 as the final captured image. The threshold value Xc may be different for different types of cameras and can be determined based on experiments performed on each type of camera.

If X_ave is less than the predetermined threshold value Xc, the controller 116 determines that the camera motion is negligible, so that the image can be captured using the normal shutter speed. The captured image data are processed using a normal image processing procedure, and the processed image data are stored in the recording device 109.

The following describes a gain increase process that uses a cell clustering method. When the higher shutter speed is used, the shutter is open for a shorter amount of time than when the normal shutter speed is used, so less photo carriers are collected by the image sensor 104. To compensate for the reduced photo carriers, the signals read out from the image sensor 104 are amplified using a cell clustering method in which the value of each cell is increased by adding the value of four neighboring cells.

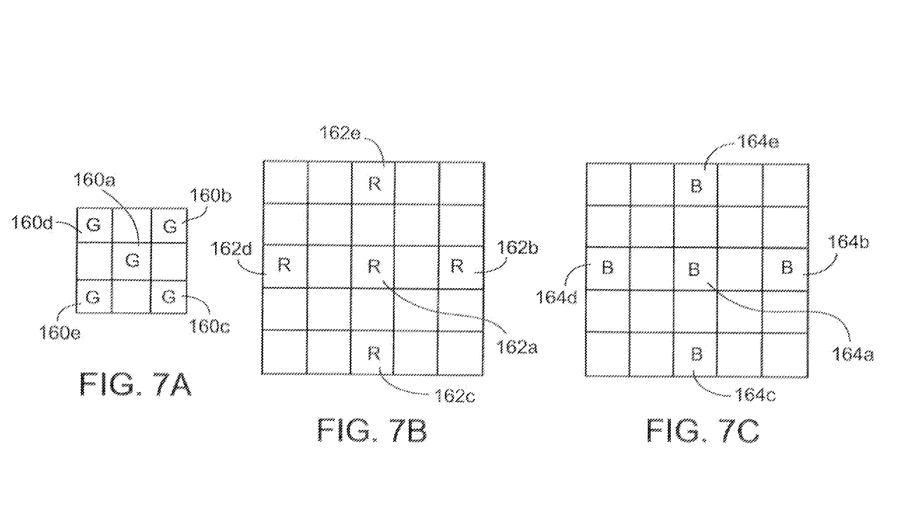

FIGS. 7A, 7B, and 7C show the arrangement of the sensor cells for detecting green, red, and blue light, respectively. More sensor cells are allocated for detecting green light because the human eye is more sensitive to the green light.

Referring to FIG. 7A, the readout value of a green sensor cell 160a can be adjusted by adding the readout values of neighboring sensor cells 160b, 160c, 160d, and 160e of the same color to the readout value of the sensor cell 160a. The final value for the sensor cell 160a may be a weighted average of the sensor cells 160a to 160e. For example, the readout values can be processed according the formula:

V′center=a×(V1+V2+V3+V4)/4+b×Vcenter, (Equ. 1)

where Vcenter, V1, V2, V3, and V4 are the readout values of cell 160a, 160b, 160c, 160d, and 160e, respectively, V′center is the final value for the sensor cell 160a, and a and b are coefficients. If a and b are selected such that the condition a+b=1 is met, then V′center will be approximately the same as Vcenter. By increasing a and/or b, V′center can become larger than Vcenter. For example, if a=4 and b=1, there will be a gain of 5 (i.e., V′center will have a value approximately equal to five times the value of Vcenter).

Similarly, referring to FIG. 7B, the value of a red sensor cell 162a can be adjusted by adding the values of sensor cells 162b, 162c, 162d, and 162e to the value of the sensor cell 162a according to a formula similar to Equ. 1. Referring to FIG. 7C, the value of a blue sensor cell 164a can be adjusted by adding the values of sensor cells 164b, 164c, 164d, and 164e to the value of the sensor cell 164a according to a formula similar to Equ. 1.

The gain increase process using the cell clustering method reduces noise due to spatial filtering. By comparison, if the readout value of the cell 160a is multiplied by four, the noise contained in the readout value will also be amplified. The resolution or sharpness of the image may be reduced when the cell clustering method is used because a feature of the object 101 is spread out to several pixels. Thus, to prevent loss of resolution of sharpness, a digital multiplication method can be used, in which the readout value of each sensor cell data is multiplied by a predetermined gain multiplication ratio. The camera 100 can be configured to automatically choose between the cell clustering method and the digital multiplication method based on an image fineness setting determined by the user. For example, suppose the camera 100 provides “Normal,” “Fine,” and “Superfine” resolution settings. If the user selects the “Normal” and “Fine” resolution settings, the cell clustering method is used, and if the user selects the “Superfine” resolution setting, the digital multiplication method is used.

By detecting camera motion using preview image data, or replacing a first image captured at a normal shutter speed with a second image captured at a higher shutter speed when camera motion is detected, memory size can be reduced, and the total operation time for obtaining a clear image can be reduced, as compared with previous methods.

A number of embodiments of the invention have been described. Nevertheless, it will be understood that various modifications may be made without departing from the spirit and scope of the invention. For example, in the digital camera 100, instead of using a mechanical shutter, an electronic shutter can be used, in which the signals from the image sensor 104 that are obtained within a preset period of time (corresponding to the opening period of a mechanical shutter) are processed as image data representing a captured image. A camcorder that is capable of capturing both videos and still images can use the methods described above for generating still images with reduced blurring. By using different color filters, the image sensor 104 can have sensor cells that detect light having colors other than red, green, and blue, such as cyan, magenta, and yellow. The image sensor 104 can be designed to capture black and white images, so that each sensor cell corresponds to a pixel in the image. In some examples of sensor cells, instead of using separate red, green, and blue pixels, as shown in FIGS. 7A to 7C, three layers of sensors each sensing red, green, and blue light can be stacked together so that red, green, and blue light can be sensed at each pixel of the image.

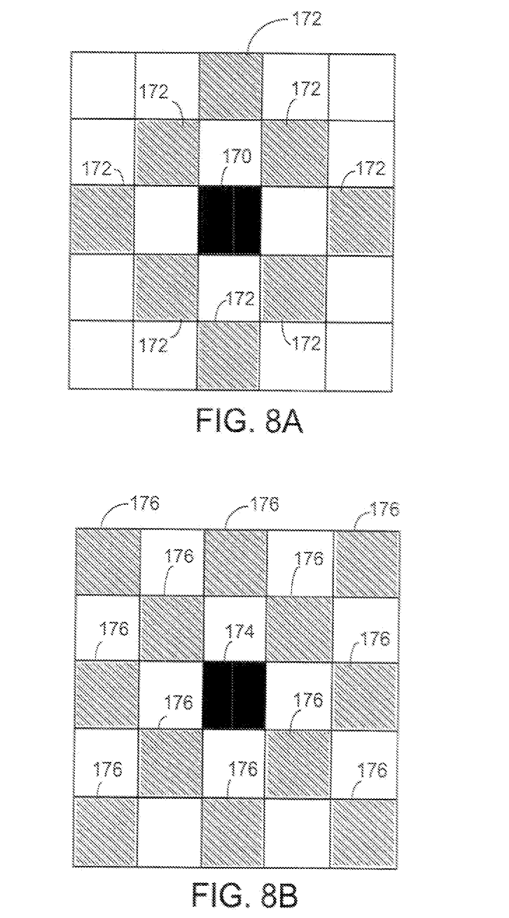

The camera 100 can use a gain increase process different from those described above. The camera 100 can adaptively switch between different gain increase methods based on criteria other than those described above. The cell clustering method can use different numbers of cells. For example, referring to FIG. 8A, the readout value of a sensor cell 170 can be adjusted by adding the readout values of eight neighboring sensor cells 172 to the readout value of the sensor cell 170. Referring to FIG. 8B, the readout value of a sensor cell 174 can be adjusted by adding the readout values of twelve neighboring sensor cells 176 to the readout value of the sensor cell 174. Instead of increasing gain of the readout values of the sensor cells when a higher shutter speed is used due to camera motion, the controller 116 can increase the aperture to increase the amount of light reaching the image sensor 104. A combination of aperture increase and gain increase can be used so that the field of depth is not significantly altered by the increase in aperture.

Two or more of the A/D converter 105, image data processor 106, motion detection module 107, auto exposure module 108, and the controller 116 can be combined in a single unit. For example, a digital signal processor or central processing unit can perform the functions of two or more of the units 105 to 108 and 116 mentioned above. The functions of these units can be achieved using hardware, software, or a combination of hardware and software. The preview image display 110 can be turned off to conserve power, while the preview image data are still processed by the image data processor 106 to detect camera motion.

Accordingly, other implementations and applications are also within the scope of the following claims.

What is claimed is:

1. A method comprising:
detecting a motion of a camera;
if camera motion is not detected, capturing an image of an object at a first shutter speed determined by the camera;
if camera motion is detected, capturing the image of the object at a second shutter speed determined by the camera, the second shutter speed being higher than the first shutter speed; and
storing image data corresponding to the captured image in a storage device.

2. The method of claim 1 wherein detecting the motion of the camera comprises comparing patterns in two preview images captured successively by the camera.

3. The method of claim 2 wherein comparing patterns in the two preview images comprises calculating correlations between a pattern at a location in a first one of the two preview images with patterns in corresponding neighboring locations in a second one of the two preview images.

4. The method of claim 2, further comprising generating a motion value based on the comparison of the patterns in the two preview images, and determining that camera motion is not detected if the motion value is less than a predetermined threshold.

5. The method of claim 1 wherein detecting the motion of the camera comprises analyzing movements of a plurality of detection areas of an image sensor of the camera.

6. The method of claim 5 wherein the motion of the camera is represented by a sum of movement distances of the plurality of detection areas.

7. The method of claim 1 wherein the second shutter speed is determined based at least in part on a level of motion of the camera.

8. The method of claim 1 wherein the second shutter speed is determined based on a predetermined relationship to the first shutter speed.

9. The method of claim 1, further comprising applying a gain increase process to image data corresponding to the captured image when the image is captured using the second shutter speed.

10. The method of claim 9 wherein the gain is increased by a ratio substantially equal to a ratio of the second shutter speed and the first shutter speed.

11. The method of claim 9 wherein the gain is increased using a cell clustering method.

12. The method of claim 11 wherein increasing the gain comprises, to a readout value from each of some of the sensor cells of the camera, adding a readout value of at least one other neighboring sensor cell.

13. The method of claim 9 wherein the gain increase process is performed by a digital multiplication method in which pixel values of the image are digitally multiplied by a gain multiplication ratio.

14. The method of claim 9, further comprising adaptively selecting the gain increase process from among at least two different gain increase processes.

15. The method of claim 14 wherein the adaptively selecting comprises adaptively selecting from a cell clustering method and a digital multiplication method to increase the gain.

16. The method of claim 1, further comprising determining the first shutter speed using an auto exposure module.

17. A method comprising:
capturing a first image of an object at a first shutter speed; and
automatically, without specific control by a user, capturing a second image at a second shutter speed that is faster than the first shutter speed upon detecting movement of the camera while the first image is being captured.

18. The method of claim 17, wherein measuring the movement of the camera comprises using a mechanical sensor to measure the movement.

19. The method of claim 17, further comprising applying a gain increase process to image data corresponding to the captured image when the image is captured using the second shutter speed.

20. The method of claim 19 wherein the gain is increased by a ratio substantially equal to a ratio of the second shutter speed and the first shutter speed.

21. The method of claim 19 wherein the gain is increased using a cell clustering method.

22. A camera comprising:
a motion detection module to detect motion of the camera;
an image sensor to capture an image and generate an image signal;
an image processing module to process the image signal from the image sensor and generate image data; and
a control module to cause the image sensor to capture the image using a first exposure time if the camera motion is not detected, and cause the image sensor to capture the image using a second exposure time if the camera motion is detected, the second exposure time being shorter than the first exposure time.

23. The camera of claim 22, further comprising an auto exposure module to determine the first exposure time.

24. The camera of claim 22, further comprising a recording device for storing the image data.

25. The camera of claim 24 wherein the controller causes first image data associated with the first image to be stored in the memory, and causes the first image data to be erased from the memory if the motion value is larger than the threshold value.

26. The camera of claim 22 wherein the motion detection module is configured to detect the camera motion by comparing patterns in a first preview image and a second preview image captured successively by the image sensor.

27. The camera of claim 26 wherein the motion detection module is configured to compare patterns in the first and second preview images by calculating correlations between a pattern at a location in the first preview image with patterns in corresponding neighboring locations in the second preview image.

28. The camera of claim 26 wherein the motion detection module is configured to generate a motion value based on the comparison of the patterns in the first and second preview images and determine that camera motion is not detected if the motion value is less than a predetermined threshold.

29. The camera of claim 22 wherein the motion detection module is configured to detect the motion of the camera by analyzing movements of a plurality of detection areas of the image sensor.

30. The camera of claim 29 wherein the motion detection module is configured to analyze movements of the detection areas by calculating a sum of movement distances of subpixels corresponding to the plurality of detection areas.

31. The camera of claim 22 wherein the motion detection module comprises a mechanical motion sensor.

32. The camera of claim 22 wherein the image processing module is configured to increase a gain of the image signal associated with the second image.

33. The camera of claim 32 wherein the image processing module is configured to increase the gain according to a ratio of the first exposure time relative to the second exposure time.

34. The camera of claim 32 wherein the image processing module is configured to increase the gain using a cell clustering method.

35. The camera of claim 34 wherein the image processing module is configured to increase the gain by adding, to a readout value of each of some sensor cells, a readout value of at least one other neighboring sensor cell.

36. An apparatus comprising:
means for capturing a first image at a first shutter speed; and
means for automatically, without specific control by the user, capturing a second image at a second shutter speed that is faster than the first shutter speed upon detecting movement of the camera while the first image is being captured.

37. The apparatus of claim 36, further comprising means for detecting the movement of the camera.
